(19) United States
(12) Patent Application Publication
(10) Pub. No.: US 2023/0341296 A1
(43) Pub. Date: Oct. 26, 2023

(54) HAND-HELD EXTERNAL TIRE READER

(71) Applicant: Tyrata, Inc., Durham, NC (US)

(72) Inventors: Michael STANGLER, Raleigh, NC (US); Shady Tarek EL BASSIOUNY, New Cairo (EG); Steven NOYCE, Durham, NC (US); Aaron Daniel FRANKLIN, Cary, NC (US); David Alan KOESTER, Burlington, NC (US); Carl Ray Prevatte, JR., Raleigh, NC (US)

(21) Appl. No.: 17/800,593

(22) PCT Filed: Mar. 1, 2021
(86) PCT No.: PCT/US2021/020200

§ 371 Date: Sep. 14, 2022

Related U.S. Application Data
(60) Provisional application No. 62/982,787, filed on Feb. 28, 2020.

(51) Int. Cl. G01M 17/02; G01B 11/22; B60C 11/24

(52) U.S. Cl. CPC G01M 17/027; G01B 11/22; B60C 11/246; B60C 25/007

(57) ABSTRACT

An external tire reader can be configured to read a tire tread. The external tire reader can include an offset structure, a camera system, and a controller. The offset structure can be configured to be applied to the tire tread. The camera system can be configured to generate an image of the tire tread while the offset structure is applied to the tire tread. The offset structure can be configured to provide a fixed distance between the camera system and the tire tread while the offset structure is applied to the tire tread. The controller can be coupled with the camera system. The controller can be configured to process the image of the tire received from the camera system.

### CROSS REFERENCE TO RELATED APPLICATIONS

This application claims the benefit of priority from U.S. Provisional Application No. 62/982,787 filed Feb. 28, 2020, the disclosure and content of which are incorporated by reference herein in their entirety.

### TECHNICAL FIELD

The present disclosure relates generally to tires, and more particularly, to tire tread monitoring systems and related methods.

### BACKGROUND

U.S. Pat. No. 9,677,973 (entitled “Method and Apparatus for Environmental Protection of Drive-Over Tire Tread Depth Optical Sensors” to Carroll et al.) discusses use of optical sensors for the acquisition of data associated with tire conditions of vehicle wheels. As further discussed, optical sensors are disposed in, or below, a supporting surface over which the vehicle wheels roll. Embedded or drive-over optical sensors may include components for projecting illuminating energy towards and onto the surfaces of a passing vehicle, as well as receiving components for capturing reflected energy from the passing vehicle. For example, some tire tread depth measurement systems consist of a laser emitter configured to project a laser light onto or across the surface of a tire passing over the optical sensor, and a cooperatively configured imaging sensor for acquiring images of the projected laser light reflected from the passing tire. Other systems/methods are discussed in U.S. Pat. No. 9,805,697 (entitled “Method for Tire Tread Depth Modeling and Image Annotation” to Dorrance et al.). Such methods/systems, however, may be costly and/or difficult to scale down to fit small enclosures.

### SUMMARY

According to some embodiments, an external tire reader configured to read a tire tread is provided. The external tire reader includes an offset structure configured to be applied to the tire tread. The external tire reader further includes a camera system configured to generate an image of the tire tread while the offset structure is applied to the tire tread. The offset structure is configured to provide a fixed distance between the camera system and the tire tread while the offset structure is applied to the tire tread. The external tire reader further includes a controller coupled with the camera system. The controller is configured to process the image of the tire received from the camera system.

Various embodiments herein allow quick and accurate monitoring of vehicle tires, which can improve car safety.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIGS. 1A-D are schematic diagrams illustrating an example of an external tire reader (“ETR”) according to some inventive concepts;

FIG. 2 is a schematic diagram illustrating an alignment frame for an ETR according to some inventive concepts;

FIG. 3 is a diagram illustrating an example of a 3D point cloud image generated based on a tire according to some inventive concepts;

FIG. 4 is a schematic diagram illustrating an example of a user interface for providing a user with output regarding tire tread measurements according to some inventive concepts;

FIG. 5 is a schematic diagram illustrating an example of a graphic representation of a tire with a matched tire profile according to some inventive concepts;

FIG. 6 is a schematic diagram illustrating an example of an ETR with multiple camera systems according to some inventive concepts;

FIG. 7 is a schematic diagram illustrating an example of an ETR with an extension according to some inventive concepts;

FIG. 8 is a block diagram illustrating an example of an ETR system according to some inventive concepts;

FIG. 9 is a block diagram illustrating an example of a remote device according to some inventive concepts; and

FIGS. 10-11 are flow charts illustrating examples of operations performed by an ETR system.

### DETAILED DESCRIPTION

Inventive concepts will be described hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

According to some embodiments of inventive concepts, a system is provided to measure tire tread depth and other characteristics of the surface profile of a tire, along with various attributes. This system is referred to as an External Tire Reader system or ETR.

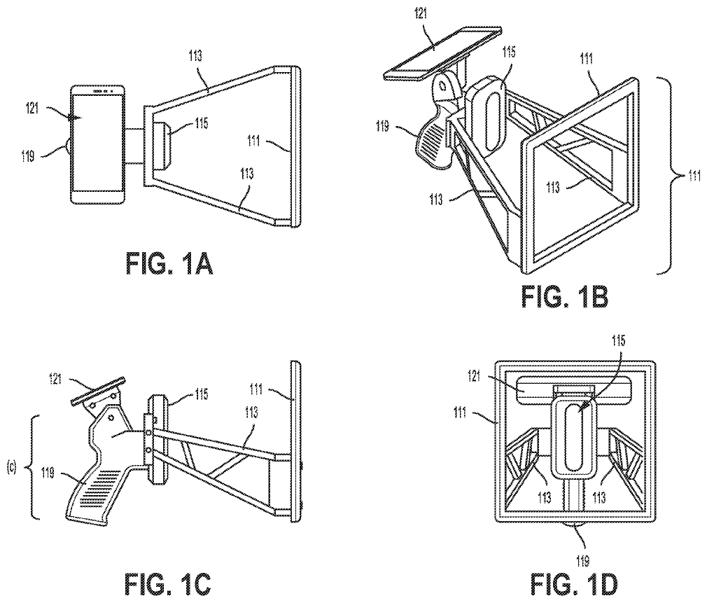

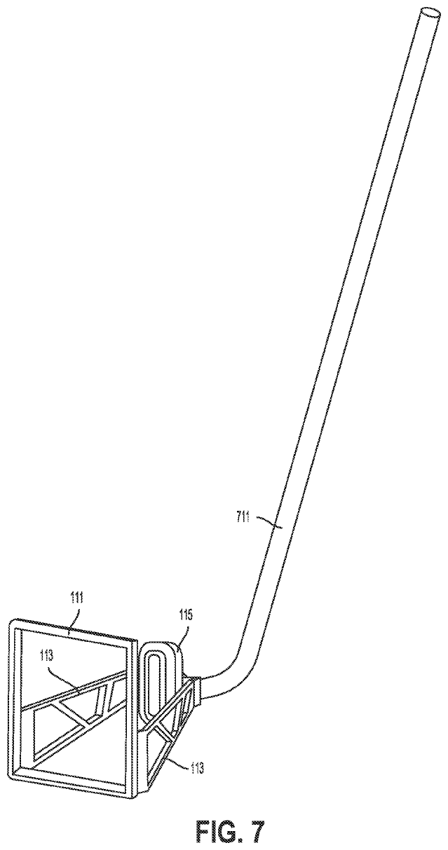

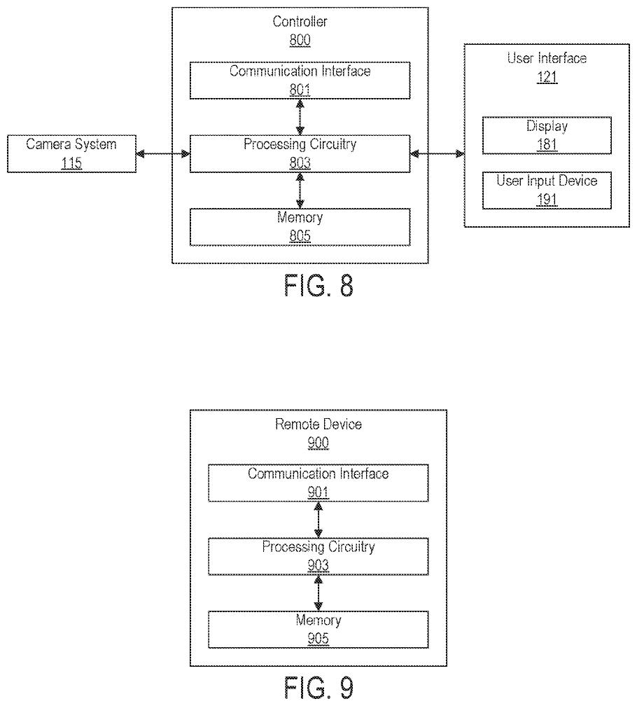

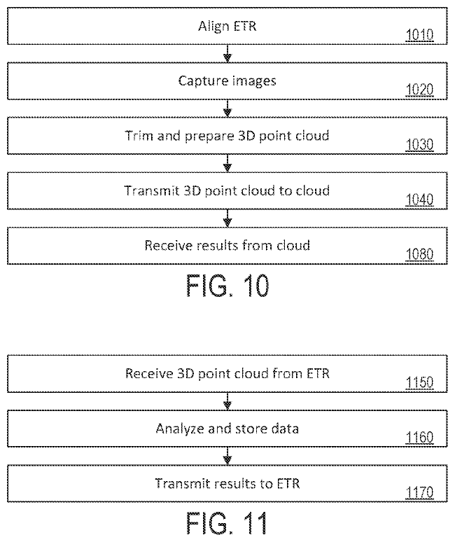

An example of an ETR system is illustrated in FIGS. 1A-D according to some embodiments of inventive concepts, and the ETR system of FIGS. 1A-D includes an offset structure (including Alignment Frame 111 and frame support 113), Dual IR camera system 115 (also referred to as camera system 115) with RGB (Red-Green-Blue) camera, Handle 119 (e.g., a pistol grip handle), and Controller and user interface 121. User interface 121 may be provided as a touch sensitive display and/or a display with other user input (e.g., a trigger on handle 119 to allow a user to initiate measurement once the frame 111 has been properly positioned on the tire). While not separately shown, electronics of the controller may be provided in/with the user interface 121, handle 119, and/or camera system 115. FIG. 1A is a top view of the ETR, FIG. 1B is a perspective view of the ETR, FIG. 10 is a side view of the ETR, and FIG. 1D is a front view of the ETR. FIG. 8 is a block diagram illustrating couplings between controller 800, camera system 115, and user interface 121.

While FIGS. 1A-D illustrate an offset structure including a frame support and a rectangular alignment frame, other offset structures that provide a fixed distance between the camera system and the tire tread while the offset structure is applied to the tire tread may be used according to other embodiments of inventive concepts. For example, the frame may include two parallel members configured to contact the tire tread across a width of the tire (without requiring perpendicular connecting members), and each of the parallel members may include a respective alignment fiducial to facilitate alignment of the camera system with the tire tread being measured. In other embodiments, an alignment frame may have a shape other than rectangular (e.g., circular, elliptical, etc.). According to still other embodiments of inventive concepts, an offset structure may provide one or a plurality of contact points, so that the fixed distance between the camera system and the tire tread is provided when the one or more contact points is/are applied to the tire tread.

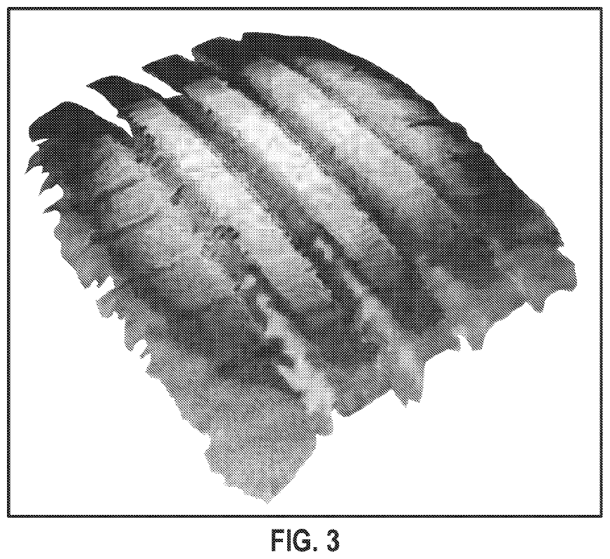

According to some embodiments of inventive concepts, the Dual IR camera system 115 of FIGS. 1A-D may use IR stereoscopic techniques to triangulate the distance of specific points on a tire tread (also referred to as a tire surface) from the two IR cameras mounted in the camera system 115. This technique may be applied herein to the measurement and profiling of tire tread surfaces. Two IR cameras (also referred to as detectors) collect IR image data from the tire tread and the data is compared to determine the relative height/depth of each measurement. An IR source (i.e., a high intensity IR lamp or LED) may provide illumination and/or structured/patterned light that is reflected back to the IR cameras. Two IR cameras are placed a fixed distance apart and may thus provide stereoscopic images that can be used to generate a 3D point cloud as shown in FIG. 3 that is used to determine a thickness/depth of the tire tread across a width of the tire. According to embodiments of FIGS. 1A-D, the camera system 115 may thus include two IR cameras that are vertically separated in the view of FIG. 1D. According to embodiments discussed below with respect to FIG. 6, each of camera systems 115A and 115 B may include two IR cameras, so that camera system 115A provides stereoscopic images of a first portion of a width of the tire used to generate a 3D point cloud for the first portion of the width of the tire, and so that camera system 115B provides stereoscopic images of a second portion of the width of the tire used to generate a 3D point cloud for the second portion of the width of the tire. The two 3D point clouds generated by the two camera systems can thus be used to determine tread thicknesses across a width of a large tire (e.g., a truck or bus tire).

The Dual IR camera system 115 may also include an RGB camera as discussed above with respect to FIGS. 1A-D, and the controller (e.g., controller 800 discussed below with respect to FIG. 8) may render an image on a display (e.g., display 181 discussed below with respect to FIG. 8) of user interface 121. For example, a live image from the RGB camera may be rendered on the display before using IR cameras to collect/generate IR data/images used to measure tread depth, and the user can use the live image from the RGB camera on the display to properly position the offset structure on the tire tread before initiating measurement. For example, portions of frame 111 (e.g., including alignment fiducials) may be in the field of view of the RGB camera so that the user sees the portions of the frame while positioning the frame against the tire tread.

The ETR is manually aligned to the surface of the tire using the frame 111 to provide/ensure proper orientation (x,y, rotation) and distance from the camera system 115 to the tire surface.

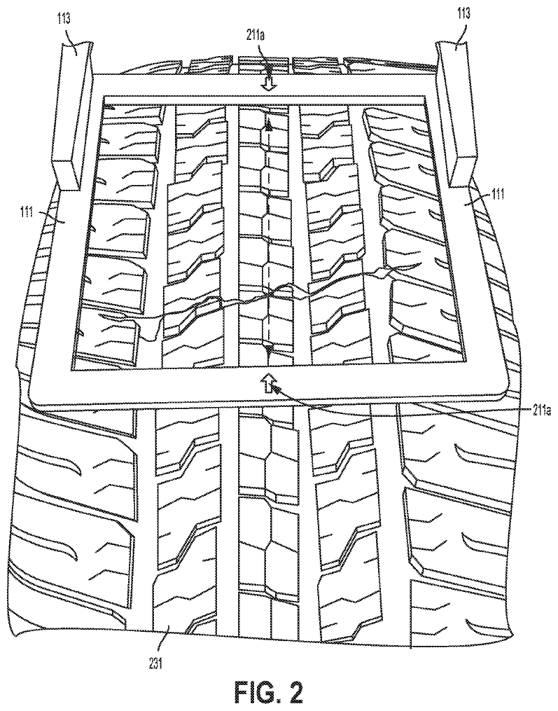

FIG. 2 is a photograph showing fiducials 211a and 211b on frame 111 to provide alignment with the groove/tread pattern. As shown in FIG. 2, the ETR alignment frame 111 may include fiducials 211a and 211b to provide/ensure alignment with the groove/tread pattern of the tire 231. The alignment frame 111 and frame support 113 provide/ensure a desired/optimal distance from the tire surface to the camera system 115.

Based on user input received through user interface 121 (e.g., responsive to the user pulling a trigger on handle 119), the ETR controller 800 generates/captures a 3D point cloud image from the surface of the tire using the dual camera system 115, and an example of such a point cloud is illustrated in FIG. 3 where different shades/colors of the point cloud represent different distances from the camera system. FIG. 3 illustrates a 3D point cloud of tire surface generated using camera system 115.

The point cloud (also referred to as an image) may be locally modified (in the controller 800) to reduce/eliminate superfluous data, (e.g. color), trimmed in size, and then sent to the cloud. For example, processing circuitry 803 may process/modify the point cloud, and processing circuitry 803 may transmit the modified point cloud through communication interface 801 to a remote processing entity (e.g., in the cloud). The communication interface 801 may provide a wired interface (e.g., an Ethernet interface) or a wireless interface (e.g., a cellular, WiFi, Bluetooth, or other wireless interface) to provide communication of the modified point cloud over a wired/wireless network to the remote processing entity.

The 3D point cloud data is analyzed in the cloud to determine/produce tread depths across the surface of the tire profile.

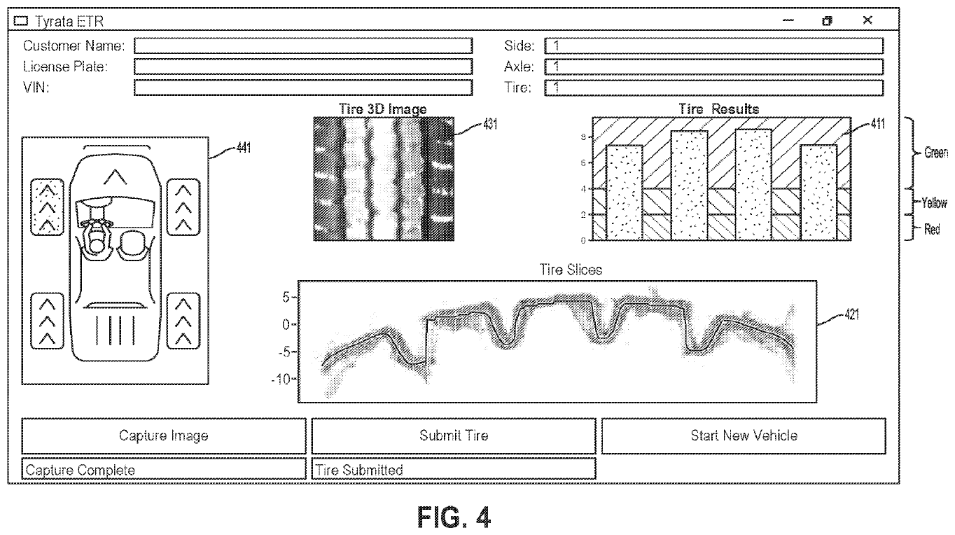

The results are returned from the cloud through the ETR communication interface 801 and displayed for the user on a display of user interface 121, to provide a user output such as that shown in FIG. 4.

FIG. 4 is an example of an ETR interface screen showing Tire 3D Image, tread depth results (bar chart) at a series of tire profiles across the tire surface (Tire Slices). The Tire Results bar chart is shown after the data is submitted to the cloud for analysis. The image/information of FIG. 4 may be displayed on the display of user interface 121.

Results with more extensive analytics can also be summarized at a customer-defined URL (Uniform Resource Locator).

FIG. 8 is a block diagram illustrating a controller 800 that may be used with various electronic tire readers discussed herein to provide tire tread depth/thickness measurement according to some embodiments of inventive concepts. As shown, the controller 800 may include a processor 803 (also referred to as processing circuitry) coupled with memory 805 (also referred to as memory circuitry) and communication interface 801 (also referred to as communication interface circuitry). Memory 805 may include computer readable program code that when executed by processor 803 causes processor 803 to perform operations according to embodiments disclosed herein. Controller 800 may also include communication interface 801 (e.g., a wired communication interface or a wireless communication interface such as WiFi, Bluetooth, etc.) coupled with processor 803 to facilitate transmission of information (e.g., image data, image point cloud/clouds, tire tread depths/thicknesses, etc.) from the processor 803 (for example, to an external display, printer, network, mobile device, remote processing entity, etc.), and/or to facilitate reception of information (e.g., tire tread depths/thicknesses) at the processor 803 (for example, from a remote processing entity). As further shown, processor 803 may receive image information from camera system 115 (or from camera systems 115A and 115B in embodiments of FIG. 6), and processor 803 may transmit information to render images on display 181. Moreover, processor 803 may receive user input through user input device 191 (e.g., a touch sensitive surface of display 181, a button/trigger on handle 119, keypad, etc.).

FIG. 9 is a block diagram illustrating a remote device 900 that may communicate with a controller 800 or other elements of an ETR system and process data associated with tire tread depth/thickness measurements according to some embodiments of inventive concepts. As shown, the remote device 900 may include processing circuitry 903 (also referred to as a processor) coupled with memory 905 (also referred to as memory circuitry) and communication interface 901 (also referred to as communication interface circuitry). Memory 905 may include computer readable program code that when executed by processor 903 causes processor 903 to perform operations according to embodiments disclosed herein. Controller 900 may also include communication interface 901 (e.g., a wired communication interface or a wireless communication interface such as WiFi, Bluetooth, etc.) coupled with processor 903 to facilitate transmission of information (e.g., image data, image point cloud/clouds, tire tread depths/thicknesses, etc.) from the processor 903 (for example, to an external display, printer, network, mobile device, remote processing entity, etc.), and/or to facilitate reception of information (e.g., tire tread depths/thicknesses) at the processor 903 (for example, from a controller 800).

FIGS. 10-11 are flowcharts illustrating operations of ETR data collection, analysis and response. FIG. 10 is described below as being performed by controller 800, but some of the operations may be performed by camera system 115 or cloud device 900. At block 1010, the ETR is aligned with the tire using frame 111 and alignment fiducials 211a and 211b (also referred to as alignment markings) as shown in FIG. 2. At block 1020, the ETR collects the image data using camera system 115. For example, a user may provide a user input (e.g., by pulling a trigger included as part of user interface 121 on handle 119) once the frame 111 and fiducials 211a-b are properly aligned, and responsive to the user input, processing circuitry 903 may cause camera system 115 to capture the image and generate the 3D point cloud as shown in FIG. 3.

At block 1030, processing circuitry 803 may trim the 3D point cloud in size, e.g., by reducing/eliminating superfluous data, (e.g. color).

At block 1040, after trimming the size of the 3D point cloud, processing circuitry 803 may transmit the 3D point through communication interface 801 (e.g., over a wired and/or wireless coupling, for example, including a wireless cellular, WiFi, Bluetooth, etc. coupling) to a remote processing entity (e.g., in the cloud).

FIG. 11 is described below as being performed by cloud device 900, but some operations may be performed by the controller 800. At block 1150, the cloud device receives the 3D point cloud from the controller 800. At block 1160, the data of the 3D point cloud may be analyzed and stored at/by the remote processing entity (e.g., in the cloud), and at block 1070, results (e.g., basic results) of the analysis may be transmitted from the remote processing entity to the ETR processor 803 through communication interface 801. In some examples, the communication interface 801 provides the results to a web-based interface for access by remote devices via the internet.

Returning to FIG. 10, at block 1080, processing circuitry 803 receives results from the remote processing entity (e.g., a cloud device). Processing circuitry 803 may use the received results to provide the information of FIG. 4 on the display of user interface 121.

According to some other embodiments, data of the 3D point cloud may be analyzed locally by processor 803 at the ETR, results of the local analysis may be used to generate the output of FIG. 4 on the display of user interface 121 without relying on or waiting for the results of remote analysis.

The output of data can be represented in a variety of ways as discussed in greater detail below.

As shown in FIG. 4, the graphic output can include a bar chart 411 enumerating the depth of each respective tire groove as a separate bar. The output can be customized to match the number and/or configuration of grooves. Depth can be color coded consistent with industry accepted values for acceptable (green), marginal (yellow), unsafe (red) and/or shades thereof. With a black-and-white, different shades may be used to indicated acceptable, marginal and unsafe ranges. As further shown in FIG. 4, the graphic output can also include a line graph 421 illustrating a profile of the tread, a 3D image of the tire 431, and/or a graphic representation 441 of the tire being analyzed.

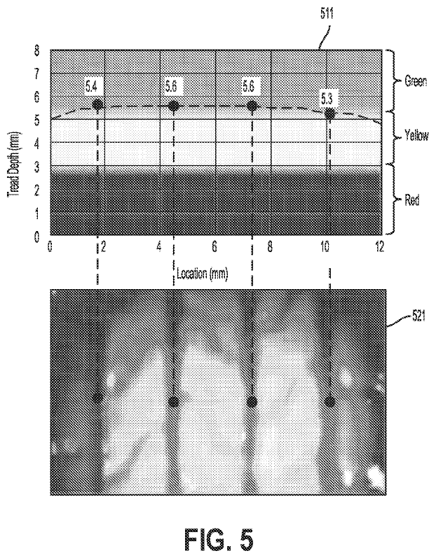

As shown in FIG. 5, the graphic output on the display of user interface 121 can include an X-Y plot 511 showing the tread depth as a function of tire location (across a width of the tire) along with a representative image 521 of the tire surface. Locator lines on the plot can be moved (e.g., using touch sensitive input of the display) to enable the user to define where the tread depth is measured.

FIG. 5 is graphic representation of tire 521 with matched tire profile 511 that may be provided on the display of user interface 121 according to some embodiments of inventive concepts.

Several structural aspects of the external tire reader are discussed below according to some embodiments of inventive concepts.

The width of the tire that can be measured is a function of the field of view from the optics of camera system 115. This is also a function of the focal distance of the optics of camera system 115. In order to gain a wider field of view for larger tires (e.g., commercial truck and bus tires), the system may be modified structurally. In some examples, the camera may be moved further from the tire surface by providing a greater distance between camera system 115 and frame 111 (e.g., extending a length of frame support 113). In additional or alternative examples, the size of the ETR may be increased. In additional or alternative examples, multiple cameras may be added at the same focal length to extend the lateral image field. Separate images can be digitally stitched together to generate a single image of the tire.

FIG. 6 illustrates embodiments of an ETR including multiple cameras (two shown) that can be placed at the same focal distance to extend a field of view, allowing wider tires to be imaged and measured. More specifically, FIG. 6 illustrates a system including two camera systems 115a and 115b coupled with frame 111 and frame support 113. While not shown in FIG. 6, the camera systems 115a-b, frame 111, and frame support 113 may be provided with a handle 119, user interface 121, and controller 800 as discussed above with respect to FIGS. 1A-D and 8. Stated in other words, the external tire reader of FIGS. 1A-D may be provided with two camera systems as shown in FIG. 6 to generate two 3D point clouds and images for different portions of the width of the tire.

In additional or alternative examples, a single camera system can be implemented that mechanically traverses the surface of the tire to capture an image of the full tire width. In the ETR of FIGS. 1A-D, for example, camera system 115 may be provided on a track with a motor to move the camera system 115 in parallel with a width of the tire. In such a system, a single camera system generates a first 3D point cloud and image in a first position of camera system 115a of FIG. 6, where the first 3D point cloud and image is provided for a first portion of the tire width. The single camera system then moves to a second position of camera system 115b of FIG. 6 where the camera system generates a second 3D point cloud and image for a second portion of the tire width. The first and second 3D point clouds and images may thus be generated for different portions of the tire width while the frame 111 is held steady against the tire.

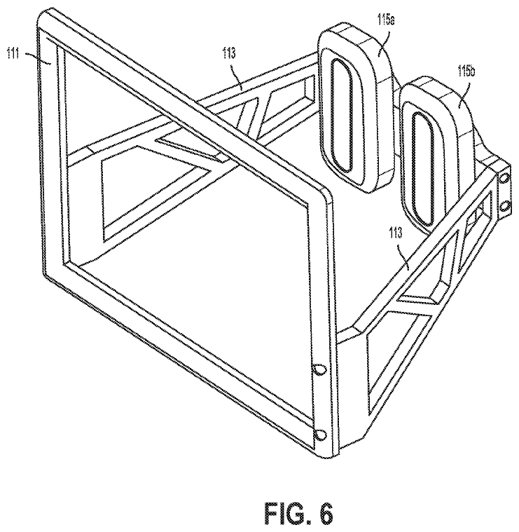

FIG. 7 illustrates embodiments with portions of an ETR mounted on an extension 711 to enable easy access to tires that are on a vehicle and on the ground or on a lift that make access otherwise difficult. This may be especially useful for access to the inner tire of a dual tire configuration. According to some embodiments illustrated in FIG. 7, the ETR may be placed on an extension 711 that enables the optics of the camera system(s) 115 and frame 111 to be more easily placed under a vehicle. The design may be modularized to enable the same camera system 115 optics and electronics to be used for either a handheld design of FIGS. 1A-D or an extension design of FIG. 7. While not shown in FIG. 7, the controller 800 and/or user interface 121 may be provided at an end of extension 711 so that the user can access the input/output elements of user interface 121 while the frame 111 and camera system are under the vehicle. In some examples, the extension 711 enables easy access to vehicles in depots and service lanes that are not on lifts. In additional or alternative examples, the extension 711 enables access to the inner tire of a dual tire configuration that cannot be easily accessed by hand. In additional or alternative examples, the extension 711 enables capturing images of tires on vehicles from a standing position.

The 3D point cloud that is generated by the camera system 115 may be altered to reduce/eliminate superfluous information and reduce the file size for subsequent transmission to the remote processing entity (e.g., a processing entity in the cloud). In some embodiments, the X,Y dimensions of the file may trimmed/cropped so that portions of the 3D point cloud that are not needed are omitted from subsequent transmission/processing. In additional or alternative embodiments, color information is omitted.

According to some embodiments of inventive concepts, one or more of the following operations/algorithms may be used. In some embodiments, peak detection may be used to identify a number and depth of groves for each cross-sectional slice. In additional or alternative embodiments, leveling may be used to remove the circumferential and/or shoulder to shoulder bow, preprocessing or presenting the rubber thickness data relative to the tire carcass. In additional or alternative embodiments, baseline extractions may be used to estimate continuous tread thickness as a function of shoulder to shoulder position for each cross-sectional slice. In additional or alternative embodiments, machine learning may be used to identify irregularities needing special attention, tire type (e.g., block tread, 3-groove, etc.). In additional or alternative embodiments, stitching may be used to tie multiple images from separate point clouds together into a continuous dataset, e.g., in embodiments using two camera systems to generate two 3D point clouds from different positions or in embodiments using one moveable camera system to generate two 3D point clouds from two different positions. In additional or alternative embodiments, Sensor Fusion may be used to improve stitching by fusing inertial measurement unit (IMU) values with frame data.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “on”, “connected”, “coupled”, “responsive”, or variants thereof to another element, it can be directly on, connected, coupled, or responsive to the other element or intervening elements may be present. In contrast, when an element is referred to as being “directly on”, “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated as “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

The dimensions of elements in the drawings may be exaggerated for the sake of clarity. Further, it will be understood that when an element is referred to as being “on” another element, the element may be directly on the other element, or there may be an intervening element therebetween. Moreover, terms such as “top,” “bottom,” “upper,” “lower,” “above,” “below,” and the like are used herein to describe the relative positions of elements or features as shown in the figures. For example, when an upper part of a drawing is referred to as a “top” and a lower part of a drawing is referred to as a “bottom” for the sake of convenience, in practice, the “top” may also be called a “bottom” and the “bottom” may also be a “top” without departing from the teachings of the inventive concept (e.g., if the structure is rotate 180 degrees relative to the orientation of the figure).

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor (also referred to as a controller) such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the following claims and their equivalents, and shall not be restricted or limited by the foregoing detailed description.

1. An external tire reader configured to read a tire tread, the external tire reader comprising:
an offset structure configured to be applied to the tire tread;
a camera system configured to generate an image of the tire tread while the offset structure is applied to the tire tread, wherein the offset structure is configured to provide a fixed distance between the camera system and the tire tread while the offset structure is applied to the tire tread; and
a controller coupled with the camera system, wherein the controller is configured to process the image of the tire received from the camera system.

2. The external tire reader of claim 1, wherein the offset structure is configured to provide the fixed distance between the camera system and the tire tread so that the tire tread is within a focal length of the camera system when the offset structure is applied to the tire tread.

3. The external tire reader of claim 1, wherein at least one alignment fiducial is provided on the offset structure and is in a field of view of the camera system.

4. (canceled)

5. The external tire reader of claim 1, wherein the offset structure includes a frame configured to be applied to the tire tread and a frame support coupled between the frame and the camera system, and
wherein the camera system is configured to generate the image of a portion of the tire tread that is surrounded by the frame while the frame is applied to the tire tread.

6. (canceled)

7. The external tire reader of claim 1, wherein the image is a first image, wherein the camera system includes a first camera configured to generate the first image of the tire tread while the offset structure is applied to the tire tread,
wherein the camera system includes a second camera configured to generate a second image of the tire tread while the offset structure is applied to the tire tread, and
wherein the controller is configured to process the first and second images of the tire received from the camera system.

8. The external tire reader of claim 7, wherein first and second alignment fiducials are provided on the offset structure,
wherein the first and second alignment fiducials define an axis, and wherein the first and second cameras are spaced apart in a direction that is at least one of:
parallel with respect to the axis; and
orthogonal with respect to the axis.

9. (canceled)

10. The external tire reader of claim 7, wherein the first and second cameras comprise respective first and second infrared (IR) cameras,
wherein the camera system includes an IR radiation source configured to project IR radiation on the tire tread while the offset structure is applied to the tire tread,
wherein the first IR camera is configured to generate the first image of the tire tread based on first reflected IR radiation from the tire tread, and
wherein the second IR camera is configured to generate the second image of the tire tread based on second reflected IR radiation from the tire tread.

11. The external tire reader of claim 7, wherein the controller is configured to process the first and second images by generating 3-dimensional (3D) point cloud information based on the first and second images.

12. The external tire reader of claim 11, wherein the controller is configured to crop the first and second images and to generate the 3D point cloud based on cropping the first and second images.

13. The external tire reader of claim 11, further comprising:
a display coupled with the controller,
wherein the controller is configured to perform at least one of:
transmit the 3D point cloud information to a remote processing entity, to receive tread measurement information based on the 3D point cloud information, and to render the tread measurement information on the display; and
generate tread measurement information based on the 3D point cloud information, and to render the tread measurement information on the display, and
wherein the controller is configured to render an image output from the camera system on the display before generating the first and second images.

14-15. (canceled)

16. The external tire reader of claim 1, wherein the camera system is configured to generate the image of the tire tread responsive to user input.

17. The external tire reader of claim 2, wherein the camera system is a first camera system,
wherein the image is a first image of a first portion of the tire tread, the external tire reader further comprising:
a second camera system configured to generate a second image of a second portion of the tire tread while the offset structure is applied to the tire tread, wherein the first and second portions of the tire tread are different,
wherein the offset structure is configured to provide the fixed distance between the first camera system and the offset structure and between the second camera system and the offset structure so that the first and second portions of the tire tread are within a focal length of the first camera system and the second camera system when the offset structure is applied to the tire tread and
wherein first and second alignment fiducials are provided on the offset structure, wherein the first and second alignment fiducials define an axis, and wherein the first and second camera systems are spaced apart in a direction that is orthogonal with respect to the axis.

18. (canceled)

19. The external tire reader of claim 1, further comprising:
a handle coupled with the offset structure and/or the camera system,
wherein the handle is a pistol grip handle with a trigger configured to accept user input, and wherein the camera system is configured to generate the image of the tire tread responsive to user input received through the trigger.

20. (canceled)

21. The external tire reader of claim 1, further comprising:
an extension coupled with the camera system and/or the offset structure; and
a display coupled with the extension and with the controller, so that the extension is between the camera system and the display, and so that the display is spaced apart from the camera system and the offset structure.

22. The external tire reader of claim 21, wherein the display is spaced apart from the camera system by at least 1 foot.

23. The external tire reader of claim 21, wherein the controller is configured to perform at least one of:
receive tread measurement information based on the image of the tire tread, and to render the tread measurement information on the display; and
generate tread measurement information based on the image of the tire tread, and to render the tread measurement information on the display, and
wherein the controller is configured to render an image output from the camera system on the display before generating the image.

24-25. (canceled)

26. The external tire reader of claim 21, wherein the camera system is configured to generate the image of the tire tread responsive to user input.

27. The external tire reader of claim 21, wherein the camera system is a first camera system,
wherein the image is a first image of a first portion of the tire tread, the external tire reader further comprising:
a second camera system configured to generate a second image of a second portion of the tire tread while the offset structure is applied to the tire tread, wherein the first and second portions of the tire tread are different, and
wherein first and second alignment fiducials are provided on the offset structure, wherein the first and second alignment fiducials define an axis, and wherein the first and second camera systems are spaced apart in a direction that is orthogonal with respect to the axis.

28. (canceled)

29. A method of operating an external tire reader configured to read a tire tread, the method comprising:
positioning, via an offset structure of the external tire reader, the external tire reader relative to the tire such that a camera system of the external tire reader is a fixed distance from the tire tread;
generating, via the camera system of the external tire reader, an image of the tire tread; and
processing, via a controller of the external tire reader, the image of the tire.

30. A non-transitory computer readable medium having instructions stored therein that are executable by processing circuitry of an external tire reader to cause the external tire reader to perform operations comprising:
generating an image of a tire tread while an offset structure of the external tire reader is applied to the tire tread, the offset structure being configured to provide a fixed distance between the camera system and the tire tread while the offset structure is applied to the tire tread; and
processing the image of the tire.
